(19) United States
(12) Patent Application Publication
(10) Pub. No.: US 2022/0100631 A1
(43) Pub. Date: Mar. 31, 2022

(54) MICROSERVICES GRAPH GENERATION

(71) Applicant: Hewlett-Packard Development Company, L.P., Spring, TX (US)

(72) Inventors: Mauricio Coutinho Moraes, Porto Alegre (BR); Daniele Antunes Pinheiro, Porto Alegre (BR); Jhonny Marcos Acordi Mertz, Porto Alegre (BR)

(73) Assignee: Hewlett-Packard Development Company, L.P., Spring, TX (US)

(21) Appl. No.: 17/424,604

(22) PCT Filed: May 15, 2019
(86) PCT No.: PCT/US2019/032492

§ 371 Date: Jul. 21, 2021

(51) Int. Cl. G06F 11/34; G06F 17/18

(52) U.S. Cl. CPC G06F 11/3452; G06F 17/18

(57) ABSTRACT

Examples are described herein of methods for generating a graph from a plurality of logs from microservices. In some examples, a method includes generating nodes of a graph based on a plurality of logs from microservices. In some examples, a method includes generating edges of the graph based on a sequence of the plurality of logs.

### BACKGROUND

Electronic technology has advanced to become virtually ubiquitous in society and has been used to improve many activities in society. For example, electronic devices are used to perform a variety of tasks, including work activities, communication, research, and entertainment. Some kinds of electronic devices include computing devices, such as personal computers, servers, laptop computers, tablet devices, smart phones, etc. Computing devices may be programmable to perform a wide variety of tasks. Due to the complexity of computing device operation, it may be difficult improve computing device performance.

### BRIEF DESCRIPTION OF THE DRAWINGS

FIG. 1 is a flow diagram illustrating an example of a method for microservices graph generation;

FIG. 2 is a block diagram of an example of an apparatus that may be used in microservices graph generation;

FIG. 3 is a block diagram illustrating an example of a computer-readable medium for microservices graph generation;

FIG. 4 is a flow diagram illustrating another example of a method for microservices graph generation; and

FIG. 5 is a block diagram illustrating an example of graph generation.

### DETAILED DESCRIPTION

Some examples of the techniques described herein relate to microservices graph generation. A microservice is a computer application that functions in coordination with a plurality of other applications (e.g., other microservices). For example, many microservices may function in a coordinated microservices architecture. In some examples, a microservice is a relatively small or lightweight application with limited functionality that coordinates with many other microservices. For example, a microservice may have a protocol for interacting with and/or communicating with other microservices. A microservice may be modular such that the microservice may be independently modified or replaced without impacting the functionality of other microservices. In some examples, microservices may be implemented in a computing device (e.g., server, network device, etc.) and may operate based on requests (e.g., hypertext transfer protocol (HTTP) requests) received by the computing device from another device (e.g., a client device).

A graph is a data structure or model. A graph may include a node or nodes (e.g., vertices) and an edge or edges (e.g., links). A node is a structure that represents an object or event. An edge is a structure that indicates a relationship. For example, an edge may indicate a relationship between different nodes (e.g., objects or events) or a relationship from a node to the same node. A graph may or may not be visually represented. In some examples, a graph may be generated and/or used without presenting a visual representation (e.g., a diagram, a rendering, etc.) of the graph. In other examples, a visual representation of a graph may be generated for presentation.

In some examples of the techniques described herein, a graph may be generated to represent the behavior of a plurality of microservices. For example, the graph may represent group behavior of a group of coordinated microservices. Group behavior is a processing sequence that characterizes the execution of microservice instructions (e.g., code or logic) of a group of coordinated microservices. The graph may be utilized to determine microservices behavior, to detect anomalous behavior, to detect behavior changes, and/or to simulate behavior. For example, a graph may provide a characterization of baseline behavior, which may indicate expected behavior for a group of microservices. In another example, a graph may provide an indication of anomalous behavior (e.g., attacks, malfunctions) and/or may be utilized to detect anomalous behavior. In another example, a graph may be generated in a simulation of microservices to indicate potential behavior of an implementation of microservices.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

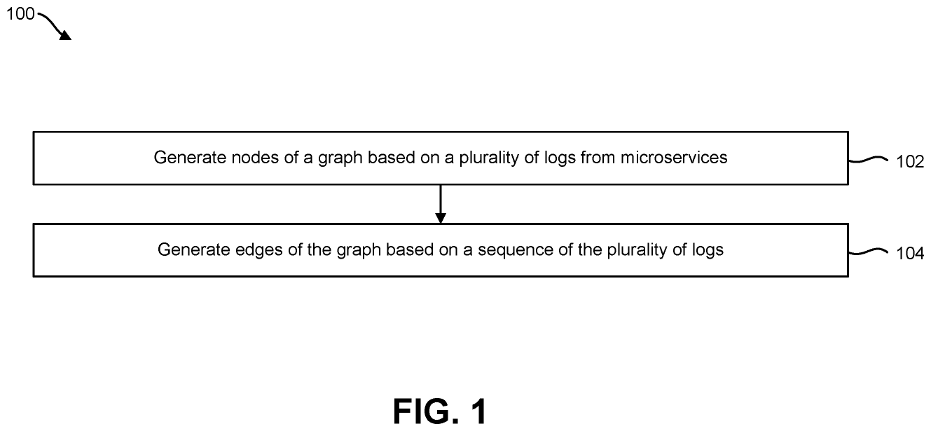

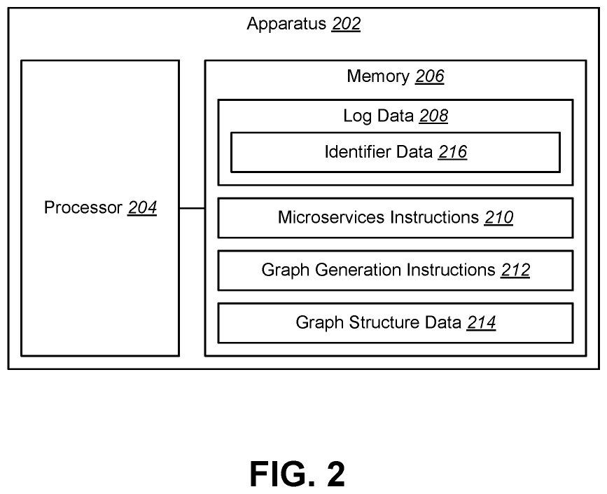

FIG. 1 is a flow diagram illustrating an example of a method 100 for microservices graph generation. The method 100 and/or a method 100 element or elements may be performed by an apparatus (e.g., electronic device, computing device, server, personal computer, tablet device, smart phone, etc.). For example, the method 100 may be performed by the apparatus 202 described in connection with FIG. 2.

The apparatus may generate 102 nodes of a graph based on a plurality of logs from microservices. A log is a processing record. For example, a log may be data produced by a microservice that indicates a microservice operation. In some examples, a log may indicate the performance of a microservice operation, the execution of a microservice instruction, an interaction between microservices (e.g., the execution of a protocol between microservices, a microservice calling another microservice, a request from a microservice to another microservice, receipt of a parameter, receipt of a parameter from another microservice, a response from a microservice to another microservice, etc.), a microservice output, and/or microservice task completion, etc. Generating 102 a node may include creating a data structure to represent the log. For example, the apparatus may generate a node as an object or variable that represents a log. For instance, the apparatus may instantiate an object or variable corresponding to a log to generate 102 the node.

In some examples, a log may include an identifier or be associated with an identifier. An identifier may identify a location of a portion of source code (e.g., a line of source code) that generated or produced the log. Examples of the identifier may include addresses, line numbers, indices, strings (e.g., function names, class names, file names, application names, etc.), container identifiers, labels, etc. Some examples of the identifier may include global identifiers. For example, a global identifier may be global such that the global identifier uniquely identifies a portion (e.g., a line) of source code for the respective log (e.g., a portion of source code that generated the respective log) in a source code repository for the microservices. For instance, a global identifier may identify a location in source code amongst source code for a plurality of microservices. In some examples, a log may include information (e.g., text, string, reference(s), character(s), number(s), etc.) in addition to the identifier.

In some examples, each of the nodes may correspond to an identifier (e.g., global identifier) of a respective log of the plurality of logs. For example, generating 102 a node may include generating an object or variable that includes the identifier as a node. In some examples, generating 102 the nodes may include, for a log entry in a log stream, adding a node to the graph in response to determining that a global identifier of the entry is not included in the graph. A log entry is a log or a log indicator (e.g., pointer, reference, etc.) in a log stream. A log stream is a plurality of logs or log entries produced by an application or applications (e.g., microservice(s)). For example, a log stream may include a sequence and/or series of log entries. In some examples, a log stream may be recorded and/or organized in accordance with a data structure (e.g., list, linked list, array, tree, etc.). In some examples, generating 102 the node may include generating a node with the identifier and without additional log information (e.g., additional text may be removed).

The apparatus may generate 104 edges of the graph based on a sequence of the plurality of logs. The sequence of the plurality of logs may be an order and/or time sequence in which the logs were produced. For example, the plurality of logs may include a period of log entries in a time-ordered log stream. For example, logs may be produced in a log stream that is ordered in time. In some examples, generating 104 an edge may include generating an edge between a first node that corresponds to a first log and a second node that corresponds to a second log that is next in the sequence following the first log.

In some examples, each of the edges is associated with a counter. A counter is a function and/or data representing a count. The counter may record transitions (e.g., a number of transitions) for an edge. For example, each time that a log A is followed by a log B (which may be denoted as A→B, for instance), the apparatus may increment the counter for the edge representing A→B.

In some examples, generating 104 the edges may include, in response to determining that the graph does not include an edge between a previous node and a current node for a log entry in a log stream, adding an edge from the previous node to the current node. Generating 104 the edges may include, in response to determining that the graph includes an edge between the previous node and the current node, incrementing a counter for the edge.

In some examples, the method 100 may include analyzing behavior of the microservices based on the graph. For example, the apparatus may utilize the graph to determine baseline behavior, to detect anomalous behavior, to detect behavior changes, and/or to simulate behavior. In some examples, analyzing behavior of the microservices may include performing statistical analysis based on the graph. For example, the apparatus may rank edges by count in ascending or descending order, may determine a percentage of total transitions for each edge, and/or may determine statistical distributions for an edge or edges based on the graph. In some examples, a baseline behavior may include or may be characterized by the ranking, the percentages, and/or the statistical distributions. For example, the ranking may characterize a group of microservices and/or a graph by proportion of edge count. In some examples, the apparatus may perform the statistical analysis based on multiple graphs (e.g., sample graphs). For instance, the statistical analysis may indicate an expected number or percentage of transitions (e.g., expected value, mean, average, etc.) for an edge or edges, a standard deviation for an edge or edges, and/or a variance for an edge or edges. In some examples, the apparatus may compare a graph to a baseline behavior and/or thresholds based on a baseline behavior to detect anomalous behavior. For instance, a standard deviation, a multiple of a standard deviation, a variance, and/or a percentile of a distribution for an edge may be utilized as a threshold. In a case that a count of an edge of the graph satisfies (e.g., exceeds, is greater than, etc.) the threshold for that edge, the apparatus may detect anomalous behavior.

In some examples, the apparatus may perform an operation based on the analysis. For example, in a case that an anomalous behavior is detected, the apparatus may send a message (e.g., email, text message, present an alarm on a display, etc.) indicating the detection of the anomalous behavior. Additionally or alternatively, the apparatus may modify operation (e.g., filter HTTP requests that are causing the anomalous behavior, redirect requests, modify microservice operation, etc.).

FIG. 2 is a block diagram of an example of an apparatus 202 that may be used in microservices graph generation. The apparatus 202 may be an electronic device, such as a personal computer, a server computer, a smartphone, a tablet computer, etc. The apparatus 202 may include and/or may be coupled to a processor 204 and/or a memory 206. In some examples, the apparatus 202 may include a display and/or an input/output interface. In some examples, the apparatus 202 may be in communication with (e.g., coupled to, have a communication link with) another device or devices. For example, the apparatus 202 may be a server that receives requests from a client or client devices. The apparatus 202 may include additional components (not shown) and/or some of the components described herein may be removed and/or modified without departing from the scope of this disclosure.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., microservices instructions 210 and/or graph generation instructions 212) stored in the memory 206. Additionally or alternatively, the processor 204 may include an electronic circuit or circuits that include electronic components for performing a function or functions of the instructions (e.g., microservices instructions 210 and/or graph generation instructions 212). In some examples, the processor 204 may perform one, some, or all of the functions, operations, elements, methods, etc., described in connection with one, some, or all of FIGS. 1-5.

The memory 206 may be any electronic, magnetic, optical, or other physical storage device that contains or stores electronic information (e.g., instructions and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include an input/output interface through which the processor 204 may communicate with another device or devices (not shown), for instance, to receive and/or respond to requests. The input/output interface may include hardware and/or machine-readable instructions to enable the processor 204 to communicate with the other device or devices. The input/output interface may enable a wired or wireless connection to the other device or devices (e.g., other computing device(s)). The input/output interface may further include a network interface card and/or may also include hardware and/or machine-readable instructions to enable the processor 204 to communicate with various input and/or output devices, such as a keyboard, a mouse, a display, a touchscreen, a microphone, another apparatus, electronic device, computing device, etc., through which a user may input instructions into the apparatus 202.

In some examples, the processor 204 may execute the microservices instructions 210 to generate, by a plurality of microservices, a plurality of logs with a plurality of identifiers. In some examples, the microservices instructions 210 may be an example of a source code repository for microservices. For instance, the microservices instructions 210 may include source code for the plurality of microservices. Different parts (e.g., address ranges, sections, etc.) of the microservices instructions 210 may include instructions (e.g., code) corresponding to different microservices.

The apparatus may store the logs. For example, the memory 206 may store log data 208. The log data 208 may be generated on the apparatus 202 and/or may be obtained (e.g., received) from another device. For example, the processor 204 may execute the microservices instructions 210 to generate the log data 208. In another example, the apparatus 202 may receive the log data 208 from another device that has executed microservices instructions.

The log data 208 may include data indicating a plurality of logs. For example, the log data 208 may indicate a log stream with a plurality of log entries. The log data 208 may include and/or indicate examples of the logs described in connection with FIG. 1.

In some examples, the log data 208 (e.g., a plurality of logs) may include identifier data 216. The identifier data 216 may include and/or indicate a plurality of identifiers. Each of the identifiers may indicate a location of a portion of source code that produced a corresponding log in the microservices instructions 210. The identifiers may be examples of the global identifiers described in connection with FIG. 1.

In some examples, the processor 204 may execute the graph generation instructions 212 to generate nodes and edges of a graph structure based on the plurality of logs with the plurality of identifiers. A graph structure is a data structure dictated by nodes and relationships between nodes as indicated by edges. For example, the processor 204 may generate nodes and edges as described in connection with FIG. 1 to produce nodes and edges of a graph structure. For instance, the processor 204 may traverse a plurality of log entries in a sequential log stream. In some examples, the processor 204 may generate a node for each identifier from the log stream that does not already have a generated node. For example, each node of the graph structure may correspond to a unique identifier of the plurality of identifiers.

In some examples, the processor 204 may generate edges corresponding to sequential transitions between logs. For example, each edge of the graph structure may correspond to a sequential transition between logs in the plurality of logs. In some examples, the processor 204 may generate an edge for each transition in the log stream that does not already have a generated edge. The processor 204 may count a number of transitions for each edge. The number of transitions may be associated with each corresponding edge.

The processor 204 may store the nodes and edges as graph structure data 214. For example, the graph structure data 214 may indicate or include a graph or graphs. A graph may include a node or nodes and an edge or edges. In some examples, an empty graph without a node or an edge may be initialized and/or stored in the graph structure data 214. Nodes and edges may indicate a graph structure. In some examples, the processor 204 may store a count of a number of transitions corresponding to each edge in the graph structure data 214.

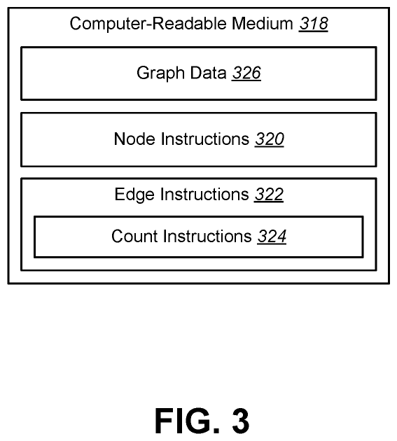

FIG. 3 is a block diagram illustrating an example of a computer-readable medium 318 for microservices graph generation. The computer-readable medium is a non-transitory, tangible computer-readable medium 318. The computer-readable medium 318 may be, for example, RAM, EEPROM, a storage device, an optical disc, and the like. In some examples, the computer-readable medium 318 may be volatile and/or non-volatile memory, such as DRAM, EEPROM, MRAM, PCRAM, memristor, flash memory, and the like. In some implementations, the memory 206 described in connection with FIG. 2 may be an example of the computer-readable medium 318 described in connection with FIG. 3.

The computer-readable medium 318 may include code (e.g., data and/or instructions). For example, the computer-readable medium 318 may include graph data 326, node instructions 320, and/or edge instructions 322.

The graph data 326 may include information pertaining to a graph or graphs (e.g., node(s) and/or edge(s)). For instance, the graph data 326 may include an example of the graph structure data 214 described in connection with FIG. 2.

In some examples, the node instructions 320 are code to cause a processor to add a node to a graph for each unique global identifier in a sequential set of log entries of a log stream from a plurality of microservices. For example, the processor may execute the node instructions 320 to add a node for each global identifier that is not associated with an existing node in a graph.

In some examples, the edge instructions 322 are code to cause the processor to add an edge to the graph for each unique sequential transition between log entries in the set of log entries. For example, the processor may execute the edge instructions 322 to add an edge for each sequential transition that is not associated with an existing edge in a graph.

In some examples, the edge instructions 322 may include count instructions 324. The count instructions 324 may be code to cause the processor to count a number of transitions for each of the edges of the graph. For example, each sequential transition between log entries in the log stream may be counted and associated with an edge of a graph. In some examples, the counts may be stored in the graph data 326.

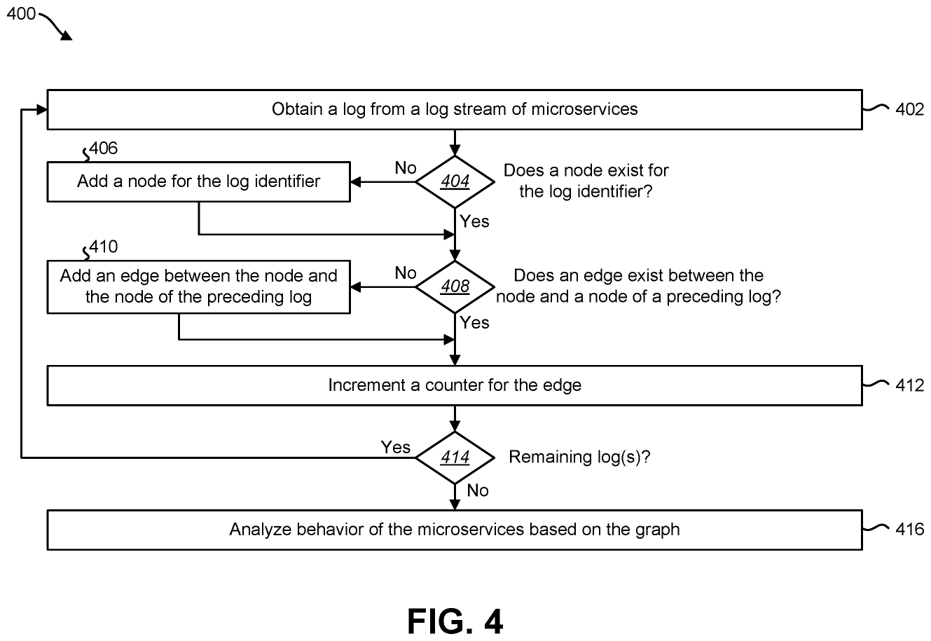

FIG. 4 is a flow diagram illustrating another example of a method 400 for microservices graph generation. In some examples, the method 400 described in connection with FIG. 4 may be an example of the method 100 described in connection with FIG. 1. In some examples, the method 400 described in connection with FIG. 4 or a function thereof may be performed by the apparatus 202 described in connection with FIG. 2. In some examples, the method 400 described in connection with FIG. 4 or a function thereof may be stored as instructions in the computer-readable medium 318 described in connection with FIG. 3.

An apparatus may obtain 402 a log from a log stream of microservices. For example, microservices may generate a log stream during execution. An apparatus may store the logs and/or arrange (e.g., sort) the logs by time, such that the logs are ordered by time. The apparatus may retrieve a log from memory, and/or may obtain a log from a microservice during execution.

The apparatus may determine 404 whether a node exists for a log identifier of the log. For example, the apparatus may determine whether a node already exists (in a graph) that includes or is associated with the log identifier. In a case that a node does not exist for the log identifier, the apparatus may add 406 a node for the log identifier to a graph. For example, the apparatus may create or generate (e.g., instantiate) a node object or variable that includes or is associated with the log identifier.

The apparatus may determine 408 whether an edge exists between the node a node of a preceding log. For example, if there is a preceding log in the log stream, the apparatus may determine whether the graph includes an edge representing a transition between the log (e.g., current log) and the immediately preceding log (e.g., most recent log before the current log). In a case that such an edge does not exist, the apparatus may add 410 an edge between the node and the node of the preceding log.

The apparatus may increment 412 a counter for the edge. For example, if a new edge is added, the apparatus may increment 412 a counter for the edge to 1. If the edge already existed, the apparatus may increment the counter by 1 (e.g., add 1 to the count for that edge).

The apparatus may determine 414 whether any log remains (or logs remain) in the log stream. In a case where a log remains (or logs remain), the apparatus may return to obtain 402 the next log from the log stream.

In a case that no log remains, the apparatus may analyze 416 behavior of the microservices based on the graph. This may be accomplished as described in connection with FIG. 1. For example, the apparatus may utilize the graph to determine baseline behavior, to detect anomalous behavior, to detect behavior changes, and/or to simulate behavior. In some examples, the apparatus may perform statistical analysis based on the graph (e.g., rank the edges in the graph, determine percentages of total transitions, determine statistical distributions, etc.). In some examples, the apparatus may compare the graph to a baseline behavior.

In some examples, the apparatus may perform an operation based on the analysis. For example, the apparatus may send a message and/or modify operation. In some examples, the apparatus may present a diagram of the graph and/or may present the analysis on a display.

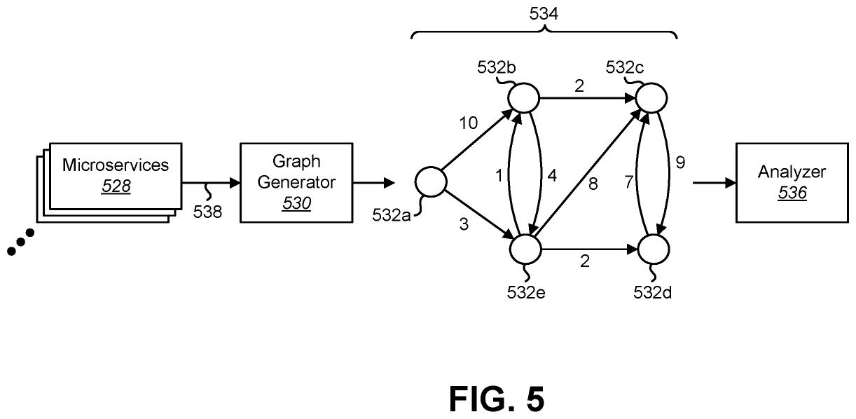

FIG. 5 is a block diagram illustrating an example of graph generation. In particular, FIG. 5 illustrates a set of microservices 528, a graph generator 530, an example of a graph diagram 534, and an analyzer 536. In some examples, the microservices 528, the graph generator 530, and/or the analyzer 536 may be implemented in the apparatus 202 described in connection with FIG. 2 and/or stored as executable instructions and/or code in the computer-readable medium 318 described in connection with FIG. 3. Additionally or alternatively, function(s) or operation(s) described in connection with FIG. 5 may be included in some examples of the method 100 described in connection with FIG. 1 and/or the method 400 described in connection with FIG. 4.

The microservices 528 may perform various operations. For example, each of the microservices 528 may provide an operation to be performed in coordination the group of microservices 528. Some examples of microservices 528 may include a user service microservice that provides a service on a website to client devices, an authorization microservice that performs authorization functions (e.g., determines whether user credentials are valid to allow access to functionality), a payment microservice that performs monetary transaction operations, an account setup microservice that adds accounts to a database of users, etc. While some examples of microservices are provided, a wide variety of additional or alternative microservices may be implemented.

The microservices 528 may produce logs 538. For example, each of the microservices 528 may be implemented to add an identifier to each log 538 that indicates a location of the code that generated the log 538. For instance, a microservice 528 may produce a log 538 that includes a string that was received as an input parameter, along with a class name (or file name or other unique identifier in the microservice 528, for example) appended to a line number of a log method call.

In some examples, each log may be implicitly or explicitly associated with a container identifier (e.g. a container identifier of a container that contains a web application that generates the log) in order to avoid collisions that may happen if multiple microservices 528 present identical class names (or file names or unique identifiers inside microservices 528, for instance). Some examples of data from a log that may be used to construct the global identifier may include a container identifier, a container name, a label, a tag, etc. In some examples, the global identifier may be a combination of a class name, line number (e.g., a code line number within the class), and container identifier.

In some examples, the logs 538 are ordered by time. For example, an apparatus may add logs 538 to a data structure (e.g., table, list, array, etc.) that is ordered by time and/or may sort logs 538 (in order by timestamps, for instance).

The graph generator 530 may automatically utilize the time-ordered log entries that are generated by a group of coordinated microservices 528 into graphs. In some examples, the graphs may be comparable to each other (by the analyzer 536, for example). For instance, the graphs may model different periods of time during the operation of the microservices 528. In some examples, the periods of time may be similar or different in length of time.

In some examples, graph generator 530 may utilize a global identifier associated with each log, without other log information. For instance, the graph generator 530 may ignore text or other information from the logs. Accordingly, the graph generator 530 may read a period-bound time-ordered log stream, log entry by log entry. The logs may be instrumented in that the global identifiers may indicate the locations of the source code (e.g., instructions) in the microservices 528 that produced the logs.

In some examples, the graph generator 530 may model log streams as graphs, in which the nodes are the global identifiers of locations of the log entries and the directed edges represent the occurrence of a sequential transition. The edges may have an associated count attribute that indicates the number that the source of the edge was followed by the target of the edge in the log entries. For example, if a log entry A is followed by log entry B 100 times in the input log stream, the resulting graph may present an edge A→B with a count attribute of 100. In some examples, log generation order may be scrambled due to computing concurrency, in which different portions of code may be executed out of order.

An example of a graph diagram 534 is illustrated in FIG. 5. The graph diagram 534 illustrates five nodes 532a-e and nine edges that are depicted as arrows between the nodes 532a-e. For example, a transition from a first node 532a to a second node 532b has occurred 10 times. The graph generator 530 may generate an edge with a count of 10 to indicate this behavior, as illustrated by the arrow between the first node 532a and the second node 532b. In some examples, the graphs described herein may be directed graphs. For instance, a transition from a fifth node 532e to the second node 532b may have occurred once, which differs from a transition from the second node 532b to the fifth node 532e that has occurred four times as depicted by the arrows in FIG. 5.

The graph(s) generated by the graph generator 530 may be provided to an analyzer 536. The analyzer 536 may perform analysis based on the graph(s). For example, the analyzer 536 may analyze the behavior of the microservices 528 based on the graph(s). In some examples, the analyzer 536 may perform the analysis described in connection with FIG. 1 and/or FIG. 4. For instance, the analyzer 536 may utilize the graph(s) to determine baseline behavior, to detect anomalous behavior, to detect behavior changes, to simulate behavior, and/or to perform statistical analysis based on the graph (e.g., rank the edges in the graph, determine percentages of total transitions, determine statistical distributions, etc.). In some examples, the apparatus may compare graphs and/or compare a graph to a baseline behavior. The analysis of the graphs may provide valuable data to support the automatic identification and comparison of emergent patterns of behaviors of the coordinated microservices 528 that generated the logs. In some examples, the analyzer 536 may perform additional or alternative graph processing techniques, such as determining minimum and/or maximum spanning trees of a graph or graphs. In some examples, the analysis and/or comparison performed by the analyzer 536 may be utilized in techniques for automatic microservices or web application understanding (e.g., identification of patterns for user modeling and behavior, attack and anomaly detection, program verification, problem diagnosis, explanation of system behavior, identification of design flaws, highlighting of new phenomena, driving system simulations, etc.).

In some examples, the analyzer 536 may produce similar rankings from similar microservices behaviors. For example, some of the techniques described herein may be resilient to high levels of concurrency, where changes in concurrency and/or activation (e.g., a probability that a thread will be activated by a microservice 528) may not significantly impact the proportional similarity between resulting graphs. In some examples, the analyzer 536 may produce significantly different rankings for different microservices behaviors. For example, some of the techniques described herein may produce significantly different graphs for different behaviors, which may indicate that the graphs may capture changing patterns of coordinated microservice group behaviors that may occur in different periods of time during operation of the microservices 528. In some examples, the analyzer 536 may group different graphs into groups with similar rankings. The groups may indicate different microservices behavior patterns.

Some examples of the techniques described herein may be beneficially resilient to high levels of concurrency and/or may be able to identify significant changes in the actual behaviors expressed in logs generated by a group of coordinated microservices in periods of time. Some examples of the techniques may beneficially provide low-cost troubleshooting, better communication, safer software development, improved overall software quality, and/or an increase in the amount of automation and generalization.

Some examples of the techniques describe herein may not utilize a training procedure (e.g., may not use labeled training data). Some examples of the techniques described herein may be applied to a group of coordinated microservices (instead of a single isolated web app, for instance). Some examples of the techniques described herein may not depend on a log grouping scheme like log tracing. Log tracing may be a technique that attempts to trace logs stemming from an HTTP request. For instance, the global identifier described herein may indicate a location in source code and/or may not indicate a particular HTTP request.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
generating nodes of a graph based on a plurality of logs from microservices; and
generating edges of the graph based on a sequence of the plurality of logs.

2. The method of claim 1, wherein each of the nodes corresponds to a global identifier of a respective log of the plurality of logs.

3. The method of claim 2, wherein the global identifier uniquely identifies a line of source code for the respective log in a source code repository for the microservices.

4. The method of claim 1, wherein generating the edges comprises generating an edge between a first node that corresponds to a first log and a second node that corresponds to a second log that is next in the sequence following the first log.

5. The method of claim 1, wherein each of the edges is associated with a counter.

6. The method of claim 5, wherein the counter records transitions for an edge.

7. The method of claim 1, further comprising analyzing behavior of the microservices based on the graph.

8. The method of claim 7, wherein analyzing the behavior comprises performing statistical analysis based on the graph.

9. The method of claim 1, wherein the plurality of logs comprises a period of log entries in a time-ordered log stream.

10. The method of claim 1, wherein generating the nodes comprises:
for a log entry in a log stream, adding a node to the graph in response to determining that a global identifier of the log entry is not included in the graph.

11. The method of claim 1, wherein generating the edges comprises:
in response to determining that the graph does not include an edge between a previous node and a current node for a log entry in a log stream, adding an edge from the previous node to the current node; and
in response to determining that the graph includes an edge between the previous node and the current node, incrementing a counter for the edge.

12. An apparatus, comprising:
a memory;
a processor coupled to the memory, wherein the processor is to:
generate, by a plurality of microservices, a plurality of logs with a plurality of identifiers; and
generate nodes and edges of a graph structure based on the plurality of logs with the plurality of identifiers.

13. The apparatus of claim 12, wherein each node of the graph structure corresponds to a unique identifier of the plurality of identifiers, and wherein each edge of the graph structure corresponds to a sequential transition between logs in the plurality of logs.

14. A non-transitory tangible computer-readable medium storing executable code, comprising:
code to cause a processor to add a node to a graph for each unique global identifier in a sequential set of log entries of a log stream from a plurality of microservices; and
code to cause the processor to add an edge to the graph for each unique sequential transition between log entries in the set of log entries.

15. The computer-readable medium of claim 14, further comprising code to cause the processor to count transitions for each edge of the graph.
